(19) United States
(12) Patent Application Publication
(10) Pub. No.: US 2014/0327519 A1
(43) Pub. Date: Nov. 6, 2014

(54) INTERACTIVE SAFETY SYSTEM

(71) Applicants: Nick Carroll, Winter Haven, FL (US); Nicolas DelCastillo, Auburndale, FL (US)

(72) Inventors: Nick Carroll, Winter Haven, FL (US); Nicolas DelCastillo, Auburndale, FL (US)

(21) Appl. No.: 14/268,179

(22) Filed: May 2, 2014

Related U.S. Application Data
(60) Provisional application No. 61/819,094, filed on May 3, 2013.

(51) Int. Cl. G08B 25/10

(52) U.S. Cl. CPC G08B 25/10
USPC 340/7.61

(57) ABSTRACT

There is disclosed an interactive system (10) for indicating the status of a given monitored area. The system includes a conventional central computer (11) which may be controlled by an administrator and several conventional remote devices (12) which are controlled by individuals. Should a threat occur a remote device user enters a “trouble” entry (danger signal) into the system into the remote device which signals the central computer. In response to the trouble entry the central computer activates the emergency response sequence which initiates a “lock down” status on the system which allows for an evaluation safety response to be entered by other remote devices. With the lock down status invoked the interface screen of the display or screen (13) of the central computer displays a map which includes color codes (visual indicators) of the status of all locations.

### REFERENCE TO RELATED APPLICATION

Applicant claims the benefit of U.S. Provisional Patent Application Ser. No. 61/819,094 filed May 3, 2013.

### TECHNICAL FIELD

This invention relates generally to an interactive system for indicating the status of a designated area.

### BACKGROUND OF INVENTION

In today's society terrorists, the mentally unstable, angry individuals, and other distraught people have taken to violent behavior. These people oftentimes target large masses of people or people associated with a distinct area, such as a select school, business, building or set of buildings.

In an effort to aid people in a select community systems, have been designed to notify individuals of a danger through a messaging system. Typically, these systems simply sends a mass email or text message to the cellular telephones of all individuals recorded in a central office. For example, a mass email of text message may be sent to all students associated with a particular school to notify them of a dangerous situation. While this type of system may warn the individual of a threat within a given area, it does not aid administrators or first responders, such as the police, in assessing where the threat may be physically located to reduce unnecessary searching and reduce resources utilized in responding to such.

Accordingly, it is seen that a need remains for a system that aids administrators and first responders in locating a threat and assessing the status of a select location. It is to the provision of such therefore that the present invention is primarily directed.

### BRIEF DESCRIPTION OF DRAWINGS

FIG. 1 is a view of an initial administrator's central computer for the system of the present invention.

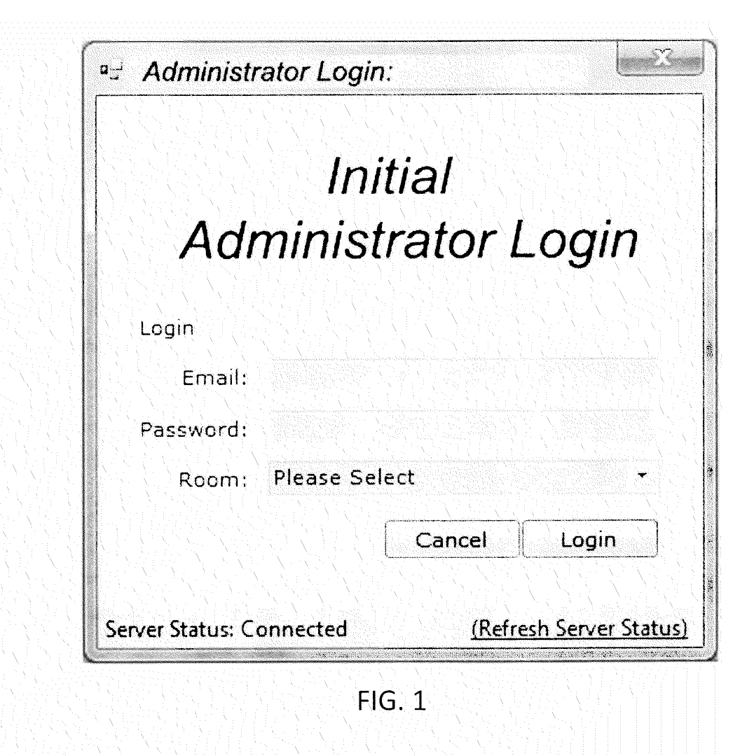

FIG. 2 is a view of the remote devices of the present invention.

FIG. 3 is a view of the initial mapping of a location utilizing the present invention.

FIG. 4 is a view of the enlarged mapping of a location utilizing the present invention, after activation of the lock-down.

FIG. 5 is a view of the enlarged mapping of a location utilizing the present invention, after activation of the lock-down and showing the position of response teams.

FIG. 6 is a view of a video image from a remote device of the present invention.

FIG. 7 is a view showing a remote devices with messaging thereon.

FIG. 8 is a flowchart showing the sequencing of events associated with the system of the present invention.

### DETAILED DESCRIPTION

With reference next to the drawings, there is shown an interactive system 10 for indicating the status of a given monitored area or location whether that be a geographic area including several buildings, a single building having multiple rooms or a combination of such. A building, room, portion, or smaller area of the entire monitored area may be considered to be a sub-area. The system 10 includes a conventional central computer 11 which may be controlled by an administrator and several conventional remote devices 12 which are controlled by individuals, such as teachers within each classroom. The remote computer includes conventional central processing unit (microprocessor), memory, a display 13 having an interface screen, wireless or wired communication systems, keyboard, etc. The remote devices 12 may be a traditional desktop computer, laptop computer, tablet computer, pda, cellular smart phone, or other similar device. The central computer 11 and remote devices 12 are enabled with a conventional software application which allows communication therebetween through conventional hardwired communications or wireless communications, such as WIFI connections, cellular connections, or other wireless communications. The software also includes conventional mapping capabilities and interactive selections and entry capabilities by such devices, all of which are conventionally programmed and stored by one skilled in the art.

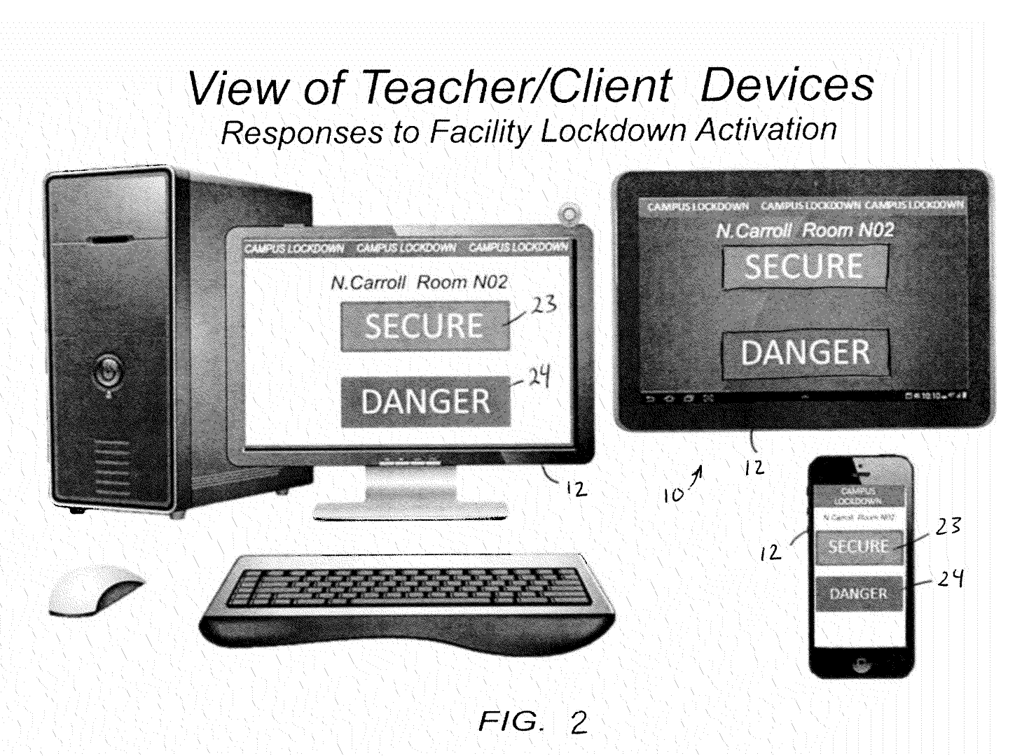

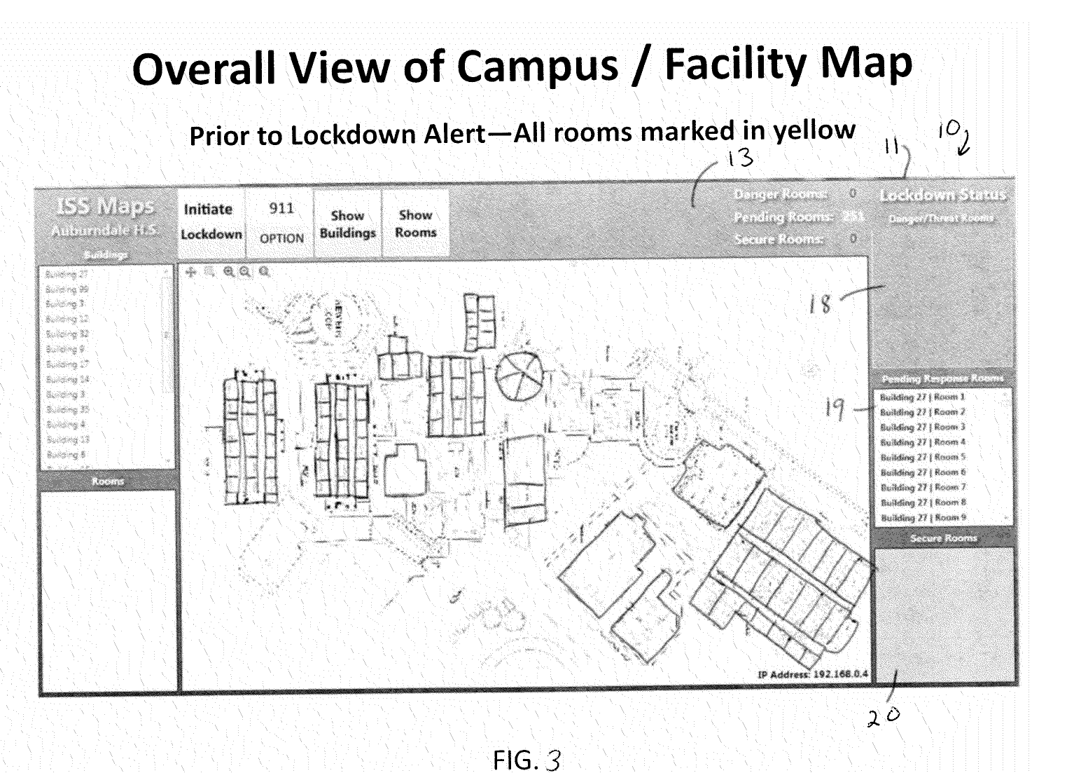

The system includes a map of the select area, shown in FIG. 3 as a college campus or facility having multiple buildings. Should a threat occur in one of the classrooms the teacher for that room, or a nearby teacher/user/client who has noticed the problem, enters a “trouble” entry (danger signal) into the system 10 through the teachers remote device 12, shown in FIG. 2. In response to the trouble entry the central computer 11 activates the emergency response sequence which initiates a “lock down” status on the system. The “lock down” status allows for an evaluation safety response to be entered by other remote devices 12. With the lock down status invoked the interface screen of the display or screen 13 of the central computer 11 displays a map which includes color codes (visual indicators) of all locations with a yellow color (yellow indicating a pending status shown by the un-shaded rooms, green indicating a secure status shown by the stippling shading, and red indicating a danger status shown by the cross-hatched shading) to indicate an unknown status for each remote location, as indicated by the un-shaped rooms in FIG. 3. The system also generates three distinct color-coded windows in the right margin to indicate the status of each room. The first or danger window 18 (red in color) indicates danger or threat rooms, the second or pending window 19 (yellow in color) indicates pending response rooms, and the third or secure window 20 (green in color) indicates secure rooms. The central computer also sends a “status indicator” request or alert signal to all remote devices 12. The status indicator request includes a color coded response indicator which provides the current status of the room or location associated with that remote device, i.e., the remote devices produce a status signal which is transmitted and received by the central computer. For example, the request may include a green secure response indicator block 23 to symbolize and the actuation of which will indicate that the area is secure or a red danger response indicator block 24 to symbolize and the actuation of which will indicate that the area is threatened or not secure, as shown in FIG. 2.

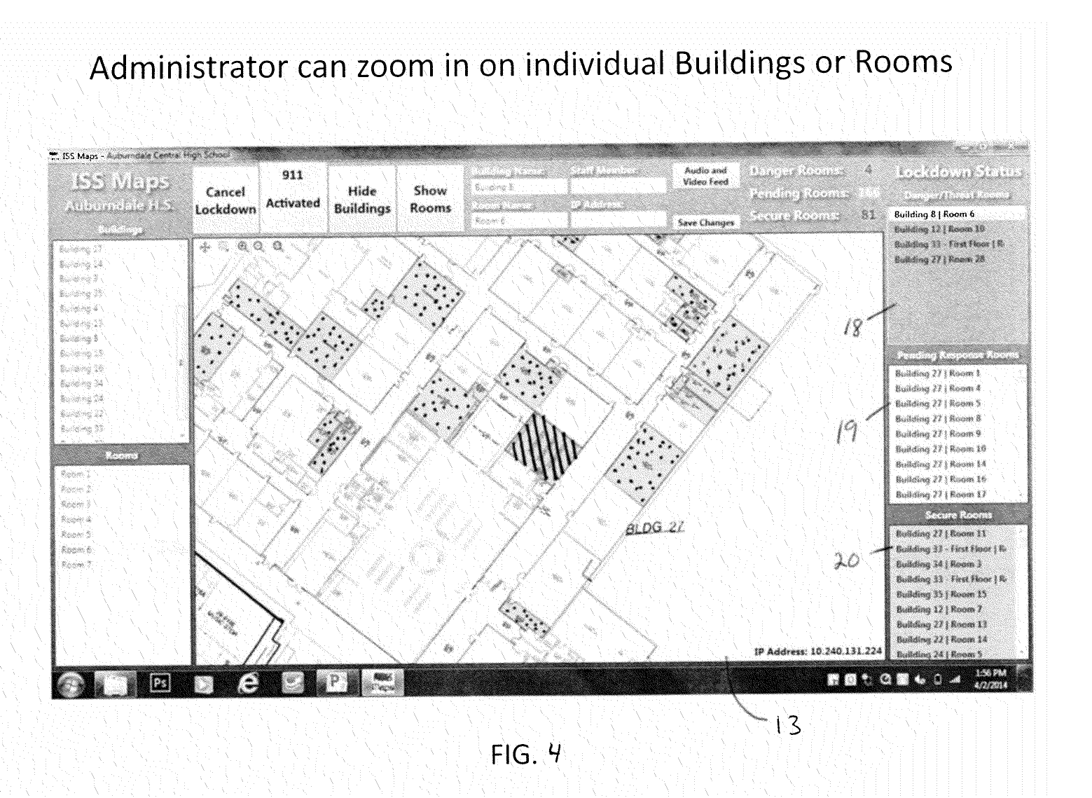

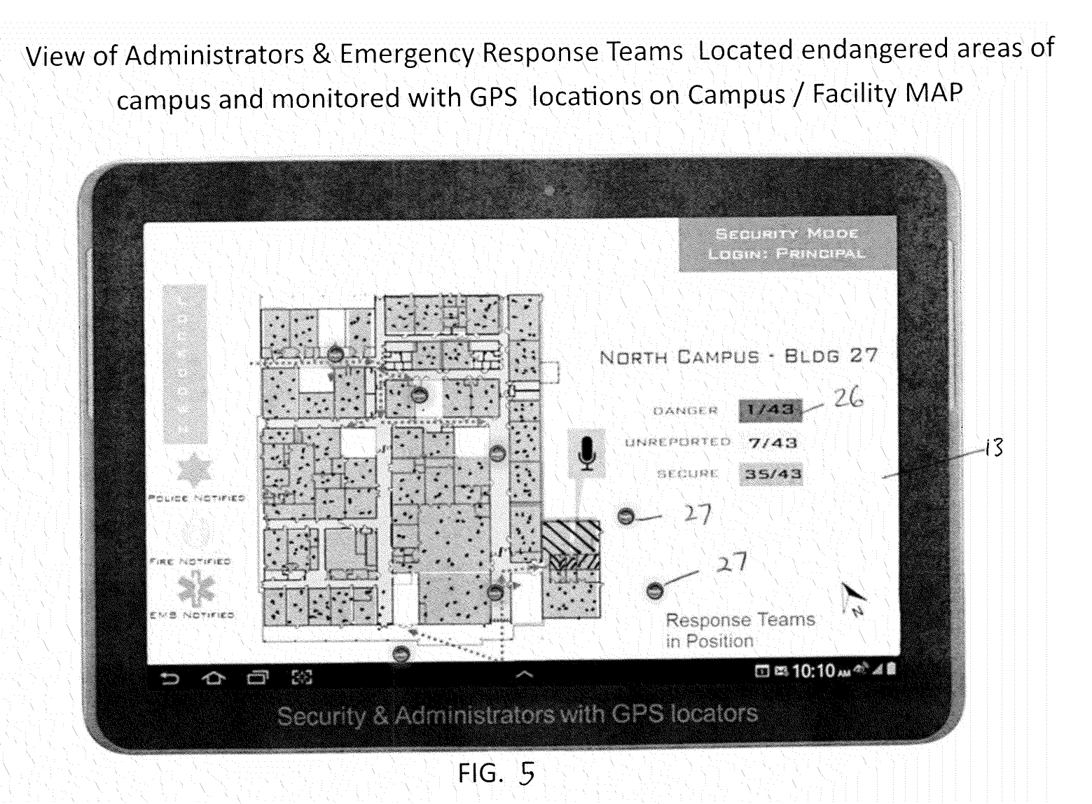

The entry of a response to the status indicator request by each remote device 12 through the entering of the appropriate response indicator block 23 or 24 provides a real time status to the administrator, which also changes the color coding associated with that particular location on the map associated with the system, changing yellow coding on rooms to green coding upon entry of the secure response indicator block 23 or changing yellow coding on rooms to red coding upon entry of the danger response indicator block 24. The system also provides a time stamp to be displayed to indicate at what time the response was provided. The time stamping allows the administrator and the first responders to view when the status was last changed so that during a fluid changing of the status the administrator and first responder may determine the location or locations that have most recently changed, which could indicate that the threat has moved to or away from the location of those devices if they have recently been changed in color. The entry of the appropriate response indicator block 23 or 24 also updates the danger window 18, pending window 19, and secure window 20 with the appropriate rooms responding or pending from the alert, as shown in FIG. 4. Also, the system may also produce and display on the display 13 a room count block 26 for each category out of a total number of rooms, as shown in FIG. 5. For example, the number of danger rooms being shown as 1/43, the number of unreported (pending) rooms being 7/43, and the number of secure rooms shown as being 35/43, meaning that 35 of the 43 total rooms are presently designated as being secure.

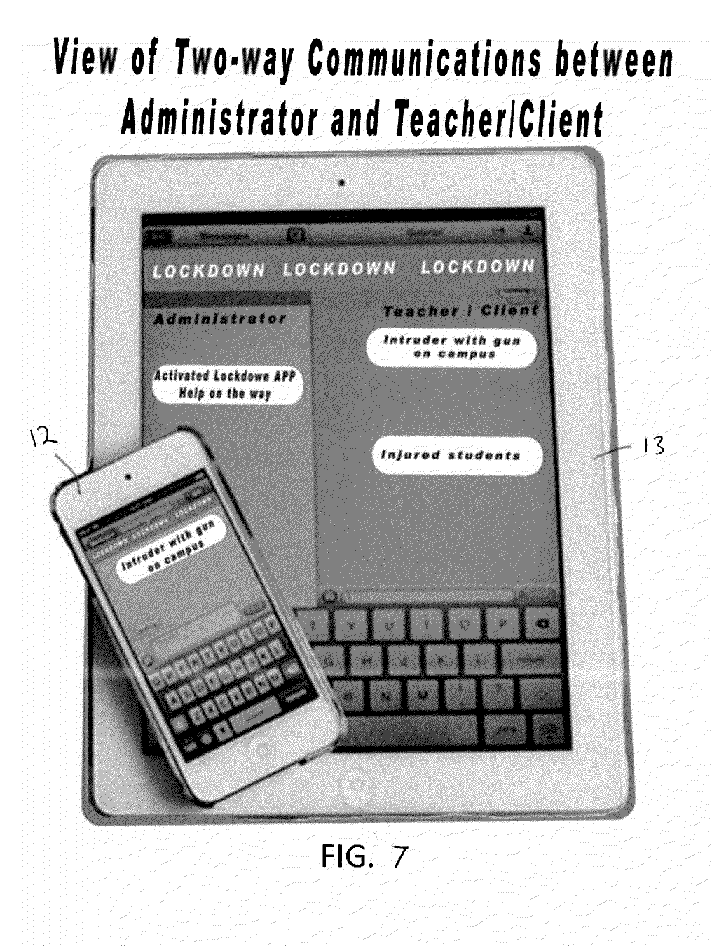

The real time mapping system also notifies the first responders, such as fire, police or emergency medical staff, and provides such with a current color coded mapping of the area so that these first responders may immediately converge on the location, indicated as being threatened, rather than being forced to work through the administration at a different location. Also, with GPS technology the location of those first responders, responder positions 27, may be included into the mapping shown upon the screen, as shown in FIG. 5. This attribute aids in tactically assessing and addressing the threat. This instant and direct access to the first responder greatly reduces the time in responding to the threat and prevents the first responders from wasting time investigating areas which are deemed secured. The central computer may also include a message indicating the type of trouble occurring at that time. For example, in FIG. 7 there is a shown remote devices 12 wherein text messages are generated to specify the threat between the teacher and the administrator to indicate that a “intruder with gun on campus”.

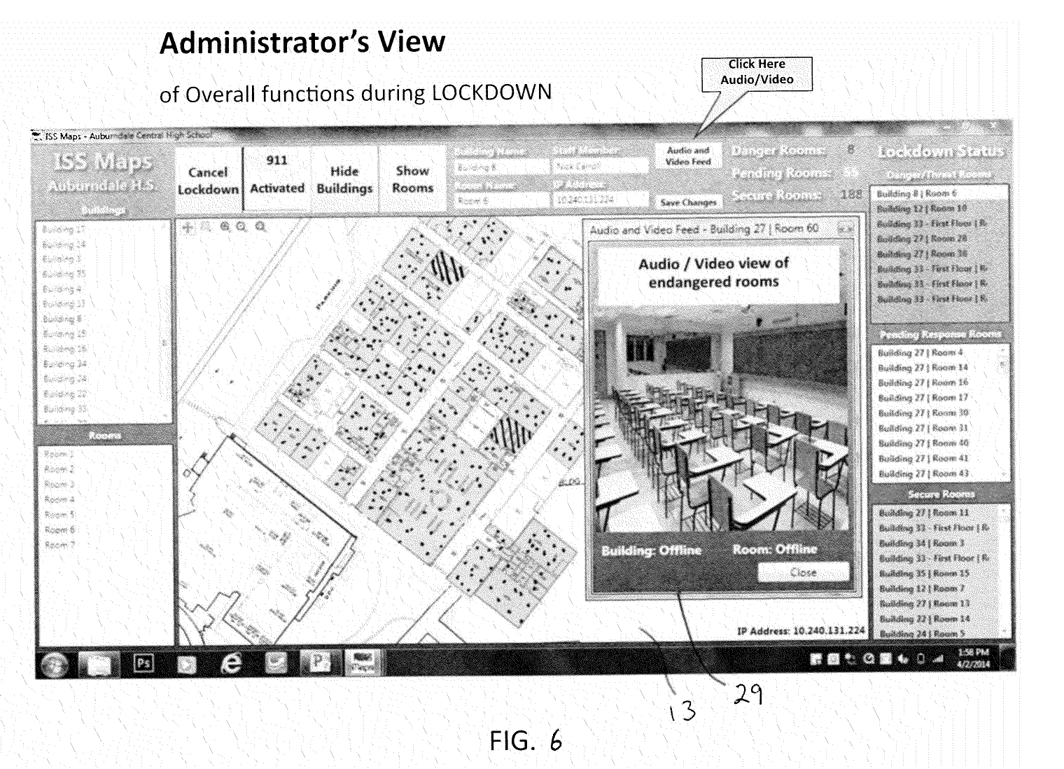

The system may also be enabled to remotely control any webcam or audio device associated with the remote devices, as shown through the video feed window 29 shown in FIG. 6. The remote controlling of these devices in this manner allows the administrator and the first responders to view and hear the scene of the remote device, i.e., hear and view the remote locations to enable the dissemination of more information. The video and audio feed may also be automatically established anytime a red or threatened response is entered by the remote device.

Through an interactive, real time response by the remote devices a color coded map is activated to indicate areas having an unknown, threatened or secured status. This information enables the administrator and the first responders the ability to immediately assess the situation and focus their attention on those area that are indicated to be under the most immediate threat, thus saving precious time and resources.

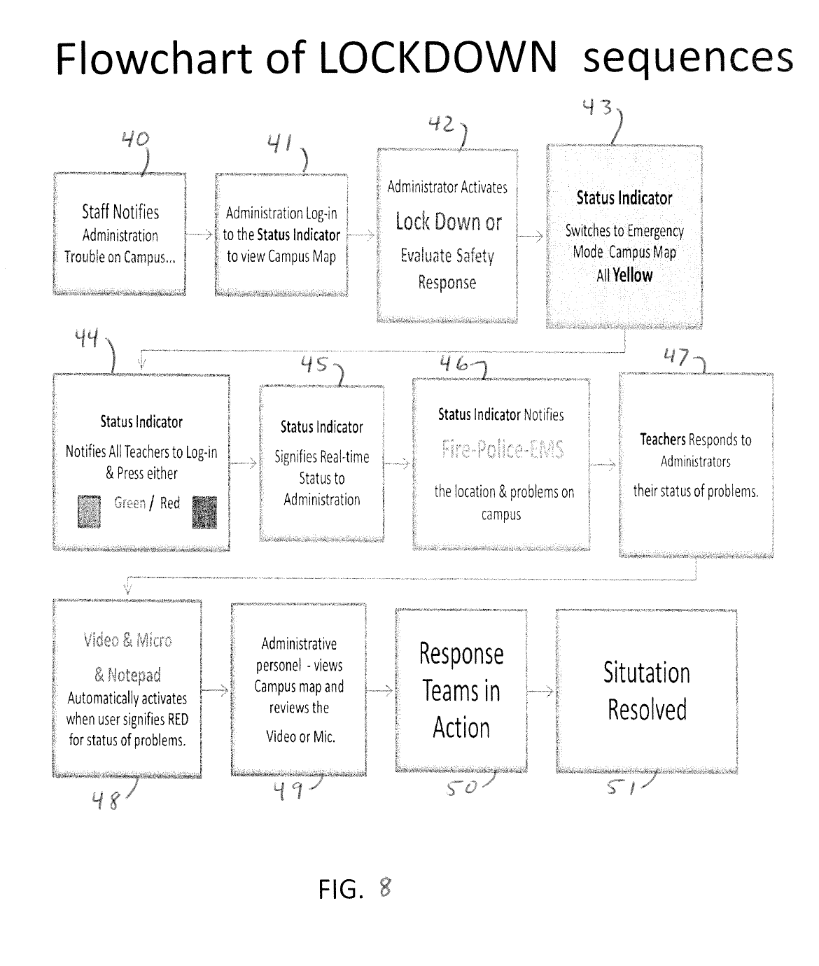

The sequencing of the system's operation is illustrated in FIG. 8, which indicates the steps of an initial message being sent 40, an administrator logging in to view map 41, the administrator initiating the lock down 42, the system switching to emergency mode 43, the system's notification to remote devices 44, the system providing real-time status of the rooms 45, the system notifying emergency providers 46, the teacher/remote device responding to the emergency mode initiation 47, the automatic activation of video and audio feeds on the remote devices 48, an administration review of the mapping 49, the first responder's actions 50, and a final indication of the resolution of the emergency situation 51.

It should be understood that the remote devices typically include GPS (global positioning system) capabilities which also aid in providing the exact location of the device, as some teachers move from one location to another during the course of a day. Also, it should be understood that the remote devices may communicate directly with the administrator through voice, text or emails to describe the situation or add further information.

It should be understood that other types of visual indicators may be utilized as a substitute to the color coding shown in the preferred embodiment, such as flashing, highlighting, stippling, cross-hatching, or other means of designating different statuses.

It thus is seen that an interactive system is now provided which overcomes problems associated with mass notification systems of the prior art. While this invention has been described in detail with particular references to the preferred embodiments thereof, it should be understood that many modifications, additions and deletions, in addition to those expressly recited, may be made thereto without departure from the spirit and scope of the invention.

1. An interactive safety system comprising,
a plurality of remote devices including remote device software installed on readable medium and containing instructions for operating said remote device, said remote device software instructions including instructions for generating a threat signal indicating the presence of a potential threat and/or for generating a status signal,
a central computer having central computer software installed on readable medium and containing instructions for operating a computer processor, said central computer software including instructions for causing the central computer processor to display on a central computer display a user interface screen, said central computer user interface screen including a visual representation of a monitored area, said visual representation including a first visual indicator representing threat sub-areas within said monitored area which are designated to be under a threat through a status signal sent from said remote devices and a second visual indicator representing non-threat sub-areas within said monitored area which are designated to not be under a threat through a status signal sent from said remote devices.

2. The interactive safety system of claim 1 wherein said first instructions further includes a third visual indicator representing pending sub-areas within said monitored area which have not yet been designated to be under a threat or not under a threat.

3. The interactive safety system of claim 1 wherein said remote devices software includes audio and/or visual capabilities for sending audio and/or visual files to said central computer, and wherein said central computer software includes audio and/or visual display capabilities for displaying the audio and/or visual files sent by said remote device.

4. The interactive safety system of claim 1 wherein said remote devices software includes location positioning data and sending capabilities, and wherein said central computer software includes instructions for correlating the received location positioning data to said visual representation of a monitored area to automatically producing the appropriate said first visual indicator or said second visual indicator according to the received status signal from said remote devices.

5. The interactive safety system of claim 1 wherein said central computer software also includes instructions for displaying the time associated with the receipt of a status signal from said remote devices.

6. The interactive safety system of claim 1 wherein said central computer software also includes instructions for indicating the most recent receipt of a status signal from said remote devices.

7. The interactive safety system of claim 1 wherein said central computer software also includes instructions for displaying a list of locations designated to be under a threat through a status signal sent from said remote devices.

8. The interactive safety system of claim 1 wherein said central computer software and said remove device software includes text messaging capabilities for sending and receiving text messages.

9. An interactive safety system comprising,
a plurality of remote devices including a processor configured to perform the task of:
(I) generating a danger signal; and
(ii) transmitting said danger signal,
a central computer system, said central computer system including a processor configured to perform the task of:
(iii) receiving a danger signal from at least one said remote devices of said interactive safety system;
(iv) generating an alert signal to said plurality of remote devices of said interactive safety system in response to receiving a danger signal from at least one said remote device;
(v) receiving a status signal from said remote devices of said interactive safety system in response to generating an alert signal, and
(vi) generating a visual representation of a monitored area which is divided into sub-areas, and visually indicating a danger status relating to sub-areas wherein a remote device associated with that sub-area has responded to the receipt of a danger signal with a danger signal.

10. The interactive safety system of claim 9 wherein step (I) the plurality of remote devices may also generate a safe signal, wherein step (ii) the plurality of remote devices may also transmit a safe signal, and wherein step (vi) the central computer may also visually indicate a safe status relating to sub-areas wherein a remote device associated with that sub-area has responded to the receipt of a danger signal with a safe signal.

11. The interactive safety system of claim 10 wherein step (vi) the central computer may also visually indicate a pending status relating to sub-areas wherein a remote device associated with that sub-area have not responded to the receipt of a danger signal.

12. The interactive safety system of claim 9 wherein said plurality of remote devices also perform the task of generating and transmitting an audio and/or visual file, and wherein said central computer also performs the task of receiving and displaying the audio and/or visual files sent by said remote devices.

13. The interactive safety system of claim 9 wherein said plurality of remote devices include location positioning data and sending capabilities, and wherein said central computer processor is configured to perform the task of correlating the received location positioning data to said visual representation of a monitored area to automatically show the visually indicating of a danger status relating to sub-areas according to the received danger signal from said remote devices.

14. The interactive safety system of claim 9 wherein said central computer processor is also configured to perform the task of displaying the time associated with the receipt of a danger signal from said remote devices.

15. The interactive safety system of claim 9 wherein said central computer processor is also configured to perform the task of indicating the most recent receipt of a danger signal from said remote devices.

16. The interactive safety system of claim 9 wherein said central computer processor is also configured to perform the task of displaying a list of locations designated to be under a threat through a danger signal sent from said remote devices.

17. The interactive safety system of claim 9 wherein said plurality of remote device processors are configured to perform the task of sending and receiving text messages, and wherein said central computer processor is also configured to perform the task of sending and receiving text messages.
